(19) United States
(12) Patent Application Publication
(10) Pub. No.: US 2023/0367737 A1
(43) Pub. Date: Nov. 16, 2023

(54) METHOD AND APPARATUS FOR PROCESSING DATA ASSOCIATED WITH A TRANSMITTER AND/OR RECEIVER DEVICE FOR A SERIAL BUS SYSTEM

(71) Applicant: RobertBoschGmbH, Stutigart (DE)

(72) Inventor: Razvan Mihalache, Stuttgart (DE)

(21) Appl. No.: 18/308,726

(22) Filed: Apr. 28, 2023

(30) Foreign Application Priority Data
May 13, 2022 (DE) 10 2022 204 720.6

(51) Int. Cl. G06F 13/42; H04L 12/40

(52) U.S. Cl. CPC G06F 13/4282; H04L 12/40; H04L 2012/40215; H04L 2012/40273; G06F 2213/0002

(57) ABSTRACT

A computer-implemented method for processing data associated with a transmitter and/or receiver device for a serial bus system. The method includes: a) exchanging first data, for example using data frames of a first type, via the serial bus system, b) exchanging second data, for example using data frames of a second type, with at least one network coupling element, for example a switch.

### CROSS REFERENCE

The present application claims the benefit under 35 U.S.C. § 119 of German Patent Application No. DE 10 2022 204 720.6 filed on May 13, 2022, which is expressly incorporated herein by reference in its entirety.

### FIELD

The present invention relates to a method for processing data associated with a transmitter and/or receiver device for a serial bus system.

The present invention further relates to an apparatus for processing data associated with a transmitter and/or receiver device for a serial bus system.

### SUMMARY

Examples of specific embodiments of the present invention relate to a method, for example a computer-implemented method, for processing data associated with a transmitter and/or receiver device for a serial bus system, the method comprising: a) exchanging first data, for example using data frames of a first type, via the serial bus system, b) exchanging second data, for example using data frames of a second type, with at least one network coupling element, for example a switch.

In further examples of specific embodiments of the present invention, provision is made for the exchange of the first data to comprise: exchanging the first data using data frames associated with the bus system, the bus system being, for example, a bus system of the CAN type, for example CAN FD, for example CAN XL, and the data frames of the first type being, for example, CAN data frames, for example CAN FD data frames, for example CAN XL data frames.

In further examples of specific embodiments of the present invention, provision is made for the exchange of the second data to comprise: exchanging the second data using data frames associated with the at least one network coupling element, the network coupling element being, for example, an Ethernet network coupling element, for example an Ethernet switch, and the data frames of the second type being, for example, Ethernet data frames. In further examples of specific embodiments, this enables an efficient data exchange in relation to Ethernet data frames, e.g. in relation to Ethernet data frames embedded in a CAN XL data frame.

In further examples of specific embodiments of the present invention, provision is made for the exchange of the second data to comprise: exchanging the second data for example directly with the network coupling element via a, for example media-independent, first interface. In further examples of specific embodiments, provision is made for the first interface to establish a direct data connection between an apparatus executing the method according to the specific embodiments, for example a CAN XL transceiver, and the network coupling element, e.g. (Ethernet) switch or a component of the network coupling element (e.g. input buffer), whereby, in further examples of specific embodiments, e.g. a direct hardware-based exchange of, e.g., Ethernet data frames between the apparatus executing the method according to the specific embodiments and the switch is enabled.

In further examples of specific embodiments of the present invention, provision is made for the method to comprise: exchanging third data with at least one further unit, for example a computing device, for example a micro-controller, for example via a second interface, the second interface being different from the first interface, for example. For example, via the second interface, data frames of the first type and/or of the second type may be at least temporarily exchanged with the at least one further unit, e.g. a micro-controller, e.g. for at least partially software-based processing of the third data.

In further examples of specific embodiments of the present invention, provision is made for the method to comprise: receiving a data frame of a first type via the serial bus system, optionally ascertaining whether the data frame of the first type comprises at least one data frame of the second type (e.g. an Ethernet data frame embedded in a CAN XL data frame) and, optionally—for example based on the ascertainment, for example if the ascertainment shows that the data frame of the first type comprises at least one data frame of the second type—extracting the at least one data frame of the second type from the data frame of the first type.

In further examples of specific embodiments of the present invention, provision is made for the method to comprise at least one of the following elements: a) analyzing the at least one data frame of the second type, for example before the extraction and/or after the extraction, b) based on the analysis (or based on a result of the analysis), for example, discarding the at least one data frame of the second type and/or the data frame of the first type, c) based on the analysis (or based on a result of the analysis), for example, outputting the at least one data frame of the second type to the network coupling element, for example directly, for example via a or the first interface, d) based on the analysis (or based on a result of the analysis), for example, outputting the at least one data frame of the second type to a further unit, for example via a or the second interface.

In further examples of specific embodiments of the present invention, provision is made for the analysis to comprise: ascertaining a target address associated with the at least one data frame of the second type, for example a MAC address (layer 2, according to the ISO/OSI layer model) and/or an IP address (Internet Protocol, layer 3).

In further examples of specific embodiments of the present invention, provision is made for the method to comprise: expanding at least one data frame (for example of the first type and/or of the second type) with or by at least one address, for example source address.

In further examples of specific embodiments of the present invention, provision is made for the method to comprise: expanding at least one data frame (for example of the first type and/or of the second type) with or by at least one VLAN (Virtual Local Area Network) tag.

In further examples of specific embodiments of the present invention, provision is made for the method to comprise: receiving fourth data to be sent via the bus system from the at least one network coupling element, for example in the form of at least one data frame of the second type, for example via a or the first interface, transmitting the fourth data via the bus system, for example in the form of at least one data frame of the first type.

In further examples of specific embodiments of the present invention, provision is made for the transmission to comprise: embedding the fourth data in at least one data frame of the first type.

In further examples of specific embodiments of the present invention, provision is made for the method to comprise: transmitting the fourth data to the further unit, for example via a or the second interface, for example using at least one data frame of the first type and/or using at least one data frame of the second type and/or using another form or another type of data frame and/or data format.

Further examples of specific embodiments of the present invention relate to an apparatus for executing the method according to the specific embodiments.

Further examples of specific embodiments of the present invention relate to an apparatus for a serial bus system, for example interface module, for example transmitter and/or receiver device, for example CAN XL transceiver, comprising at least one apparatus according to the specific embodiments.

Further examples of specific embodiments of the present invention relate to a network coupling element, for example switch, for example automotive switch, comprising at least one apparatus according to the specific embodiments.

Further examples of specific embodiments of the present invention relate to a control unit, for example for a vehicle, for example motor vehicle, comprising at least one apparatus according to the specific embodiments and/or at least one network coupling element according to the specific embodiments.

Further examples of specific embodiments of the present invention relate to a, for example serial, bus system, for example for a vehicle, for example motor vehicle, comprising at least one apparatus according to the specific embodiments and/or at least one network coupling element according to the specific embodiments and/or at least one control unit according to the specific embodiments.

Further examples of specific embodiments of the present invention relate to a communications system, for example for a vehicle, for example motor vehicle, comprising at least one apparatus according to the specific embodiments and/or at least one network coupling element according to the specific embodiments and/or at least one control unit according to the specific embodiments and/or at least one bus system according to the specific embodiments.

Further examples of specific embodiments of the present invention relate to a computer-readable storage medium, including commands which, when executed by a computer, prompt this latter to execute the method according to the specific embodiments.

Further examples of specific embodiments of the present invention relate to a computer program, including commands which, when the program is executed by a computer, prompt this latter to execute the method according to the specific embodiments.

Further examples of specific embodiments of the present invention relate to a data-carrier signal, which carries and/or characterizes the computer program according to the specific embodiments.

Further examples of specific embodiments of the present invention relate to use of the method according to the specific embodiments and/or of the apparatus according to the specific embodiments and/or of the network coupling element according to the specific embodiments and/or of the control unit according to the specific embodiments and/or of the bus system according to the specific embodiments and/or of the communications system according to the specific embodiments and/or of the computer-readable storage medium according to the specific embodiments and/or of the computer program according to the specific embodiments and/or of the data-carrier signal according to the specific embodiments for at least one of the following elements: a) exchanging data, b) enabling, for example, direct communication, for example data communication, between the transmitter and/or receiver device and at least one network coupling element, for example Ethernet network coupling element, for example switch, c) hardware-based, for example purely hardware-based, transfer of at least one data frame of the second type, for example from the bus system to at least one network coupling element and/or vice versa, d) at least temporarily avoiding software-based processing of data frames of the second type, for example within an apparatus executing the method according to the embodiments, e) increasing efficiency with regard to processing—for example transferring—data frames of the second type, for example in connection with carrying the data frames of the second type via the bus system, f) directly transferring at least one Ethernet data frame, which is embedded in a CAN XL data frame or extracted from a CAN XL data frame, for example from a CAN XL transceiver to a network coupling element.

Further features, possible applications and advantages of the present invention can be found in the description below of exemplary embodiments of the present invention, which are depicted in the figures. All described or depicted features, either individually or in any combination, form the subject matter of the present invention regardless of the wording or depiction thereof in the description or in the figures.

### BRIEF DESCRIPTION OF THE DRAWINGS

FIG. 1 shows a simplified flow chart according to examples of specific embodiments of the present invention.

FIG. 2 shows a simplified block diagram according to examples of specific embodiments of the present invention.

FIG. 3 shows a simplified flow chart according to examples of specific embodiments of the present invention.

FIG. 4 shows a simplified block diagram according to examples of specific embodiments of the present invention.

FIG. 5 shows a simplified flow chart according to examples of specific embodiments of the present invention.

FIG. 6 shows a simplified flow chart according to examples of specific embodiments of the present invention.

FIG. 7 shows a simplified block diagram according to examples of specific embodiments of the present invention,

FIG. 8 shows a simplified block diagram according to examples of specific embodiments of the present invention.

FIG. 9 shows a simplified block diagram according to examples of specific embodiments of the present invention.

FIG. 10 shows a simplified block diagram according to examples of specific embodiments of the present invention.

FIG. 11 shows aspects of uses according to further examples of specific embodiments of the present invention.

### DETAILED DESCRIPTION OF EXAMPLE EMBODIMENTS

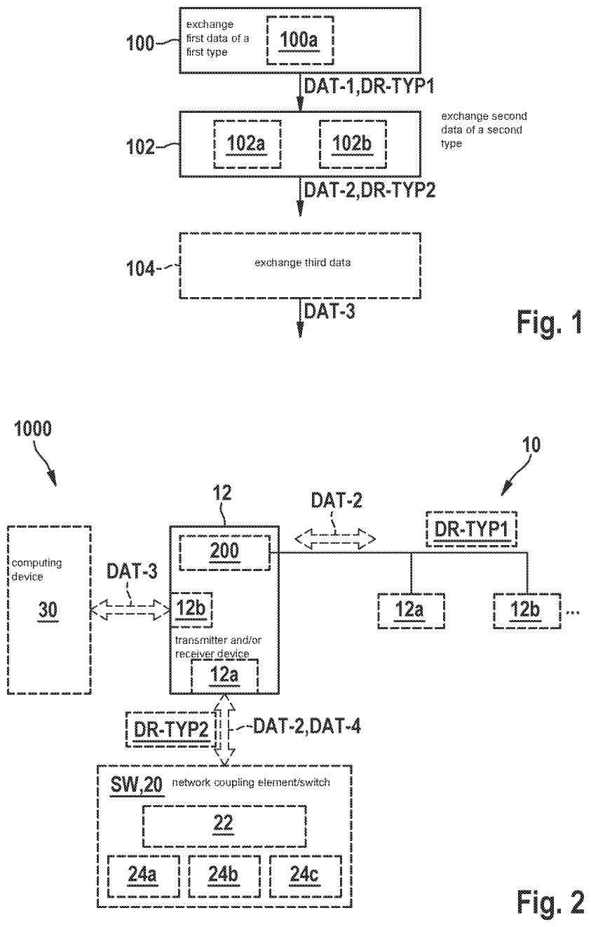

Examples of specific embodiments, FIG. 1, relate to a method, for example a computer-implemented method, for processing data associated with a transmitter and/or receiver device 12 (FIG. 2) for a serial bus system 10, the method comprising: a) exchanging 100 (FIG. 1) first data DAT-1, for example using data frames DR-TYP1 of a first type, via the serial bus system 10, b) exchanging 102 second data DAT-2, for example using data frames DR-TYP2 of a second type, with at least one network coupling element 20 (FIG. 2), for example a switch.

In further examples of specific embodiments, FIG. 1, provision is made for the exchange 100 of the first data DAT-1 to comprise: exchanging 100a the first data DAT-1 using data frames DR-TYP1 associated with the bus system 10, the bus system 10 being, for example, a bus system of the CAN type, for example CAN FD, for example CAN XL, and the data frames DR-TYP1 of the first type being, for example, CAN data frames, for example CAN FD data frames, for example CAN XL data frames.

In further examples of specific embodiments, FIG. 1, provision is made for the exchange 102 of the second data DAT-2 to comprise: exchanging 102a the second data DAT-2 using data frames DR-TYP2 associated with the at least one network coupling element 20, the network coupling element 20 being, for example, an Ethernet network coupling element, for example an Ethernet switch, and the data frames DR-TYP2 of the second type being, for example, Ethernet data frames. In further examples of specific embodiments, this enables an efficient data exchange in relation to Ethernet data frames DR-TYP2, e.g. in relation to Ethernet data frames DR-TYP2 embedded in a CAN XL data frame DR-TYP1. In particular, in further examples of specific embodiments, processing—e.g. intermediate processing in software—of the relevant Ethernet data frames DR TYP2 may thus be avoided since, for example, the principle according to the specific embodiments enables, e.g. purely, hardware-based processing, for example transfer, of Ethernet data frames DR-TYP2, e.g. for exchanging the Ethernet data frames between the bus system 10 and the switch 20.

In further examples of specific embodiments, FIG. 1, provision is made for the exchange 102 of the second data DAT-2 to comprise: exchanging 102b the second data DAT-2 for example directly with the network coupling element 20 via a, for example media-independent, first interface 12a (FIG. 2) (e.g. xRMII interface).

In further examples of specific embodiments, FIG. 2, provision is made for the first interface 12a to establish or comprise a direct data connection between an apparatus 12 executing the method according to the specific embodiments, for example a CAN XL transceiver, and the network coupling element, e.g. (Ethernet) switch 20 or a component 22 of the network coupling element 20, whereby, in further examples of specific embodiments, e.g. a direct hardware-based exchange of, e.g., Ethernet data frames between the apparatus 12, 200 executing the method according to the specific embodiments and the switch 20 is enabled.

In further examples of specific embodiments, e.g. in addition to the direct data connection to the first interface 12a, the switch comprises, for example, multiple connections 24a, 24b, 24c for connecting further apparatuses (not shown) designed, e.g., as Ethernet data sources and/or Ethernet data sinks.

In further examples of specific embodiments, FIG. 1, provision is made for the method to comprise: exchanging 104 third data DAT-3 with at least one further unit 30 (FIG. 2), for example a computing device, for example a micro-controller, for example via a second interface 12b, the second interface 12b being different from the first interface 12a, for example. Via the second interface 12b, data frames of the first type and/or of the second type may, for example, be at least temporarily exchanged with the at least one further unit, e.g. a micro-controller, e.g. for at least partially software-based processing of the third data DAT-3 by the micro-controller. On the other hand, a purely hardware-based data exchange e.g. of Ethernet data frames which are embedded in CAN XL data frames, e.g. between the bus system 10 and the switch 20, may take place via the apparatus 12, which is connected to the bus system 10, and its first interface 12a.

By way of example, the apparatus 12 may be designed as a bus participant for the bus system 10. The bus system 10 may optionally comprise further bus participants 12a, 12b, . . . .

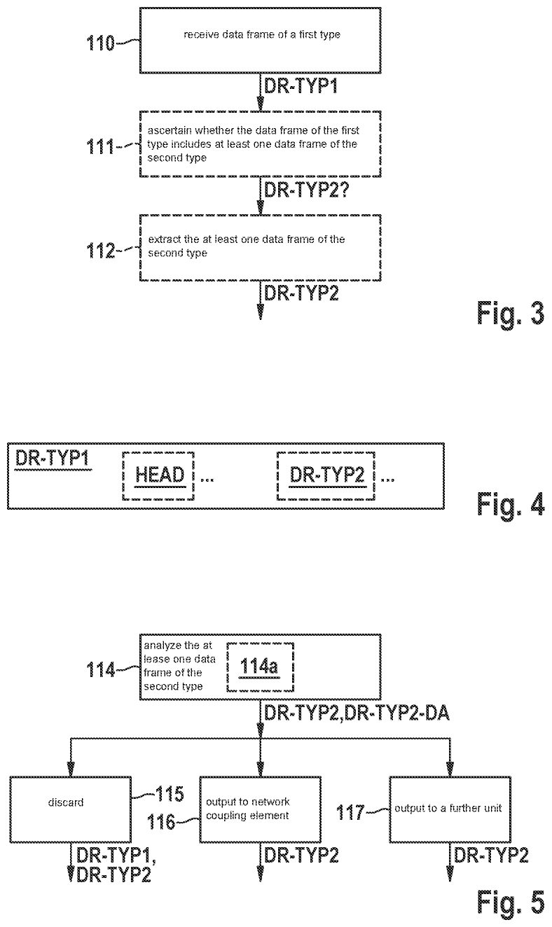

In further examples of specific embodiments, FIG. 3, provision is made for the method to comprise: receiving 110 a data frame DR-TYP1 of a first type via the serial bus system 10 (FIG. 2), optionally ascertaining 111 whether the data frame of the first type comprises at least one data frame DR-TYP2 of the second type (e.g. an Ethernet data frame embedded in a CAN XL data frame) and, optionally—for example based on the ascertainment 111, for example if the ascertainment 111 shows that the data frame DR-TYP1 of the first type comprises at least one data frame DR-TYP2 of the second type—extracting 112 the at least one data frame DR-TYP2 of the second type from the data frame DR-TYP1 of the first type.

FIG. 4 shows a schematic illustration of an example of a CAN XL data frame DR-TYP1 of the at least one Ethernet data frame DR-TYP2. The CAN XL data frame DR-TYP 1 shown by way of example in FIG. 4 may be used, for example, to carry at least one Ethernet data frame DR-TYP2 via the bus system 10, for example within the context of a tunneling method.

In further examples of specific embodiments, an identifier may be provided e.g. in header data HEAD of the CAN XL data frame DR-TYP 1, e.g. in an SDT field of the header data, e.g. in the form of a value “4” or “5” for the SDT field of the header data HEAD, which identifier indicates whether the CAN XL data frame DR-TYP 1 is associated with a tunneling method for at least one Ethernet data frame, for example with a tunneling method according to IEEE 802.3, e.g. “Ethernet tunneling” (value “4”) or “Ethernet mapped tunneling” (value “5”). Therefore, in further examples of specific embodiments, e.g. native Ethernet data frames DR-TYP2 may be carried within a CAN XL data frame DR-TYP2.

In further examples of specific embodiments, FIG. 5, provision is made for the method to comprise at least one of the following elements: a) analyzing 114 the at least one data frame DR-TYP2 of the second type, for example before the extraction 112 (FIG. 3) and/or after the extraction 112, b) based on the analysis 111 (or based on a result of the analysis 111), for example, discarding 115 (FIG. 5) the at least one data frame DR-TYP2 of the second type and/or the data frame DR-TYP1 of the first type, c) based on the analysis 111 (or based on a result of the analysis 111), for example, outputting 116 the at least one data frame DR-TYP2 of the second type to the network coupling element 20, for example directly, for example via the first interface 12a (FIG. 2), d) based on the analysis 111 (or based on a result of the analysis 111), for example, outputting 117 the at least one data frame DR-TYP2 of the second type to a further unit 30 (FIG. 2), for example via the second interface 12b.

In further examples of specific embodiments, FIG. 5, provision is made for the analysis 114 to comprise: ascertaining 114a a target address DR-TYP2-DA associated with the at least one data frame DR-TYP2 of the second type, for example a MAC address (layer 2, according to the ISO/OSI layer model) and/or an IP address (Internet Protocol, layer 3). By way of example, at least some aspects of at least some of the examples of blocks 114, 115, 116, 117 according to FIG. 5 may be executed based on the ascertained target address DR-TYP2-DA.

In further examples of specific embodiments, provision is made for the method to comprise: expanding at least one data frame (for example of the first type and/or of the second type) with or by at least one address, for example source address.

In further examples of specific embodiments, provision is made for the method to comprise: expanding at least one data frame (for example of the first type and/or of the second type) with or by at least one VLAN (Virtual Local Area Network) tag.

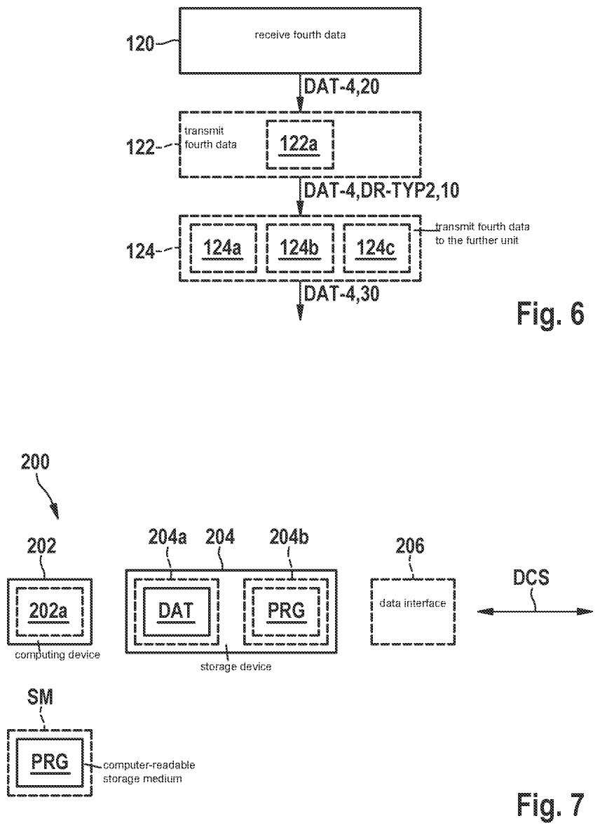

In further examples of specific embodiments, FIG. 6, provision is made for the method to comprise: receiving 120 fourth data DAT-4 to be sent via the bus system 10 (FIG. 2) from the at least one network coupling element 20, for example in the form of at least one data frame DR-TYP2 of the second type, for example via the first interface 12a, transmitting 122 (FIG. 6) the fourth data DAT-4 via the bus system 10, for example in the form of at least one data frame DR-TYP1 of the first type.

In further examples of specific embodiments, FIG. 6, provision is made for the transmission 122 to comprise: embedding 122a the fourth data DAT-4 in at least one data frame DR-TYP1 of the first type.

In further examples of specific embodiments, FIG. 6, provision is made for the method to comprise: transmitting 124 the fourth data DAT-4 to the further unit 30 (FIG. 2), for example via the second interface 12b, for example using 124a at least one data frame of the first type and/or using 124b at least one data frame of the second type and/or using 124c another form or another type of data frame and/or data format.

Further examples of specific embodiments, FIG. 7, relate to an apparatus 200 for executing the method according to the specific embodiments.

In further examples of specific embodiments, provision is made for the apparatus 200 to comprise: a computing device (computer) 202 comprising at least one computing core 202, a storage device 204 associated with the computing device 202 for at least temporarily storing at least one of the following elements: a) data DAT (e.g. at least some of the data DAT-1, DAT-2, DAT-3, DAT-4), b) computer program PRG, for example for executing the method according to the specific embodiments.

In further examples of specific embodiments, the storage device 204 comprises a volatile memory (e.g. random access memory (RAM)) 204a, and/or a non-volatile memory (NVM) (e.g. flash EEPROM) 204b, or a combination thereof or with other storage types not explicitly mentioned.

Further examples of specific embodiments, FIG. 7, relate to a computer-readable storage medium SM, including commands PRG which, when executed by a computer 202, prompt this latter to execute the method according to the specific embodiments.

Further examples of specific embodiments, FIG. 7, relate to a computer program PRG, including commands which, when the program PRG is executed by a computer 202, prompt this latter to execute the method according to the specific embodiments.

Further examples of specific embodiments, FIG. 7, relate to a data-carrier signal DCS, which characterizes and/or carries the computer program PRG according to the specific embodiments. The data-carrier signal DCS can be received, for example, via an optional data interface 206 of the apparatus 200. In further examples of specific embodiments, the optional data interface 206 symbolizes a functionality of the first interface 12a (FIG. 2) and/or of the second interface 12b and/or of a bus interface for connecting e.g. the apparatus 12 to the bus system 10.

In further examples of specific embodiments, the configuration described by way of example above with reference to FIG. 7 or a functionality of the apparatus 200 can be realized in the form of a hardware circuit and/or a programmable logic circuit, e.g. FPGA, and/or an application-specific integrated circuit, e.g. ASIC, which can be integrated e.g. in the apparatus 12 (FIG. 2) or at least in another bus participant 12a, 12b.

Further examples of specific embodiments, FIG. 2, relate to an apparatus 12 for a serial bus system 10, for example to an interface module 12, for example transmitter and/or receiver device 12 (transceiver), for example CAN XL transceiver 12, comprising at least one apparatus 200 (or a corresponding functionality of the apparatus 200) according to the specific embodiments.

Further examples of specific embodiments, FIG. 2, relate to a network coupling element 20, for example switch SW, for example automotive switch, comprising at least one apparatus 200 according to the specific embodiments.

Further examples of specific embodiments, FIG. 2, relate to a network coupling element 20, for example switch SW, which is designed to receive data frames DR-TYP2 of the second type from a further device, e.g. from a transceiver 12, e.g. CAN XL transceiver 12, and to process them. The switch SW may, e.g., also be optionally designed to transmit data frames DR-TYP2 of the second type to the further device, e.g. the transceiver 12, e.g. CAN XL-transceiver 12.

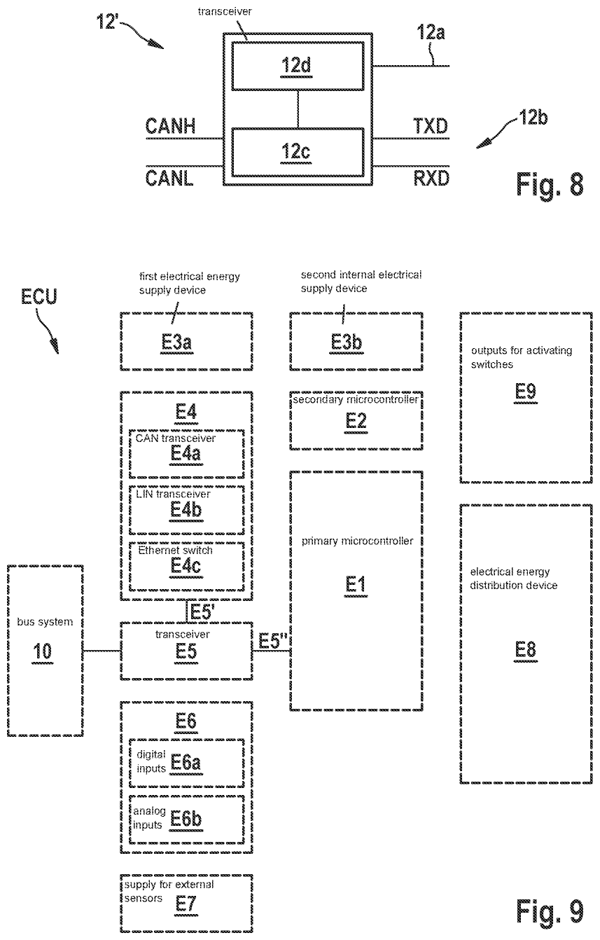

FIG. 8 shows a schematic illustration of a simplified block diagram of a transceiver, e.g. CAN XL transceiver 12′, e.g. for the bus system 10 according to FIG. 2, according to further examples of specific embodiments. The transceiver 12′ can be connected to the corresponding bus lines (not shown) of the bus system 10 via two lines CANH, CANL, and, e.g., to a computing device, e.g. the micro-controller 30 (FIG. 2), via two further lines TXD, RXD. By way of example, the two further lines TXD, RXD symbolize the second interface 12b according to FIG. 2. As already described above, data, e.g. in the form of data frames DR-TYP2 of the second type, e.g. Ethernet data frames, can be exchanged between the transceiver 12′ and the switch 20 (FIG. 2), for example directly, for example purely on a hardware basis, via the first interface 12a.

Element 12c according to FIG. 8 symbolizes a fundamental functionality of the transceiver 12′, for example comprising at least one of the following elements: a) receiving data frames DR-TYP1, e.g. CAN XL data frames, from the bus system 10 (FIG. 2), b) communicating data associated with the received data frames to the micro-controller 30 via at least one of the lines TXD, RXD, c) receiving data which is to be sent via the bus system 10 from the micro-controller 30 via at least one of the lines TXD, RXD, d) transmitting data frames DR-TYP1 associated with the data to be sent, which is received by the micro-controller 30, via the bus system 10.

Element 12d according to FIG. 8 symbolizes a functionality which goes beyond the functionality 12c and comprises, for example, at least one aspect of the method according to the specific embodiments and/or, e.g., aspects of a CAN controller. By way of example, the element 12d in further examples of specific embodiments may realize or implement at least some aspects of the apparatus 200 or the functionality of the apparatus 200; in the present case, for example, extracting Ethernet frames which are possibly contained in CAN XL data frames received by the bus system 10 and transferring or outputting the extracted Ethernet data frames, e.g. directly to the switch 20, e.g. via the first interface 12a.

In further examples of specific embodiments, e.g. Ethernet traffic (comprising one or more data frames DR-TYP2 of the second type) coming into the transceiver 12′, e.g. via the CAN XL bus 10 (FIG. 2), can be transmitted both to the switch 20 connected via the first interface 12a and also to the micro-controller (“μC”) 30, e.g. a host μC 30. If, e.g., the host μC does not require the incoming CAN XL/Ethernet data frames (which, in further examples of specific embodiments, can be ascertained, e.g., via block 12d), then, e.g., the block 12d may suppress the non-required data frames, e.g. immediately, so that, e.g., they are not transmitted to the micro-controller 30 in the first place.

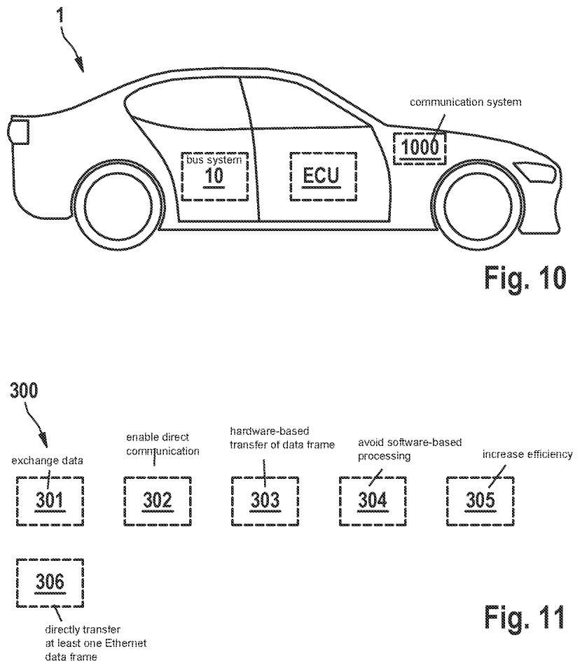

Further examples of specific embodiments, FIG. 9, relate to a control unit ECU, for example for a vehicle, for example motor vehicle 1 (FIG. 10), comprising at least one apparatus 200 (FIG. 7) according to the specific embodiments or to a functionality of the apparatus 200 and/or to at least one network coupling element according to the specific embodiments.

In further examples of specific embodiments, the control unit may be designed, e.g., as a zone control unit, e.g. zone ECU, or as a domain ECU or, e.g., as a vehicle computer.

Element E1 symbolizes, for example, an, e.g. primary, micro-controller, which supports e.g. ASIL (Automotive Safety Integrity Level) C or ASIL D. Element E2 symbolizes, for example, an optional secondary micro-controller, e.g. for redundancy purposes and/or for monitoring and/or controlling the operation of the primary micro-controller E1. Element E3a symbolizes, for example, a first electrical energy supply device, element E3b symbolizes, for example, a second, e.g. internal electrical energy supply device. Element E4 symbolizes, for example, components for communication, comprising e.g. a CAN transceiver E4a, a LIN transceiver E4b and an Ethernet switch E4c.

Element E5 symbolizes, for example, a transceiver 12, 12′ according to examples of specific embodiments, see e.g. FIG. 2, 8, which can be connected to the bus system 10. The transceiver E5 comprises a direct data connection E5′ to the Ethernet switch E4c, e.g. similarly or identically to the first interface 12a according to FIG. 2. The transceiver E5 furthermore comprises a direct data connection E5″ to the primary micro-controller E1, e.g. similarly or identically to the second interface 12b according to FIG. 2.

Element E6 symbolizes, for example, inputs, e.g. digital inputs E6a and/or analog inputs E6b. Element E7 symbolizes, for example, a supply for external sensors (not shown). Element E8 symbolizes, for example, an electrical energy distribution device. Element E9 symbolizes, for example, outputs, for example for activating switches, e.g. high-side switches and/or low-side switches, and/or for activating bridges, e.g. half bridges and/or full bridges.

Further examples of specific embodiments, FIG. 10, relate to a, for example serial, bus system 10, for example for a vehicle 1, for example motor vehicle, comprising at least one apparatus 200 (FIG. 7) according to the specific embodiments and/or at least one network coupling element SW (FIG. 2) according to the specific embodiments and/or at least one control unit ECU according to the specific embodiments.

Further examples of specific embodiments, FIG. 2, 10, relate to a communications system 1000, for example for a vehicle 1, for example motor vehicle, comprising at least one apparatus 200 (FIG. 7) according to the specific embodiments and/or at least one network coupling element according SW (FIG. 2) according to the specific embodiments and/or at least one control unit ECU according to the specific embodiments and/or at least one bus system 10 according to the specific embodiments.

Further examples of specific embodiments, FIG. 11, relate to use 300 of the method according to the specific embodiments and/or of the apparatus 12, 12′, 200 according to the specific embodiments and/or of the network coupling element 20, SW according to the specific embodiments and/or of the control unit ECU according to the specific embodiments and/or of the bus system 10 according to the specific embodiments and/or of the communications system 1000 according to the specific embodiments and/or of the computer-readable storage medium SM according to the specific embodiments and/or of the computer program PRG according to the specific embodiments and/or of the data-carrier signal DCS according to the specific embodiments for at least one of the following elements: a) exchanging 301 data, b) enabling 302, for example direct, communication, for example data communication, between the transmitter and/or receiver device 12 and at least one network coupling element 20, for example Ethernet network coupling element, for example switch, c) hardware-based, for example purely hardware-based, transfer 303 of at least one data frame of the second type, for example from the bus system 10 to at least one network coupling element and/or vice versa, d) at least temporarily avoiding 304 software-based processing of data frames of the second type, for example within an apparatus executing the method according to the specific embodiments, e) increasing 305 efficiency with regard to processing—for example transferring—data frames of the second type, for example in connection with carrying the data frames of the second type via the bus system, f) directly transferring 306 at least one Ethernet data frame, which is embedded in a CAN XL data frame or extracted from a CAN XL data frame, for example from a CAN XL transceiver to a network coupling element.

In further examples of specific embodiments, the principle according to the specific embodiments may be e.g. at least temporarily applied, e.g., to CAN XL data frames containing Ethernet data frames DR-TYP2, whilst, for example, CAN and/or CAN FD and/or CAN XL data frames which do not comprise Ethernet data frames (e.g. embedded therein) may be processed, for example, according to conventional methods. In other words, in further examples of specific embodiments, aspects according to the specific embodiments which relate to, e.g., CAN XL data frames containing Ethernet data frames DR-TYP 2 are transparent to CAN (CAN DF, CAN XL) data frames which do not comprise Ethernet data frames.

What is claimed is:

1. A computer-implemented method for processing data associated with a transmitter and/or receiver device for a serial bus system, the method comprising the following steps:
a) exchanging first data using data frames of a first type via the serial bus system;
b) exchanging second data using data frames of a second type, with at least one network coupling element.

2. The method as recited in claim 1, wherein the exchanging of the first data includes: exchanging the first data using data frames associated with the bus system, wherein the bus system is a bus system of a CAN type, and wherein the data frames of the first type are CAN data frames.

3. The method as recited in claim 1, wherein the exchanging of the second data includes: exchanging the second data using data frames associated with the at least one network coupling element, wherein the network coupling element is an Ethernet network coupling element, and wherein the data frames of the second type are Ethernet data frames.

4. The method as recited in claim 1, wherein the exchanging of the second data includes: exchanging the second data directly with the network coupling element via a media-independent, first interface.

5. The method as recited in claim 4, further comprising:
exchanging third data with at least one further unit via a second interface, wherein the second interface is different from the first interface.

6. The method as recited in claim 1, further comprising:
receiving a data frame of a first type via the serial bus system;
ascertaining whether the data frame of the first type includes at least one data frame of the second type;
based on the ascertainment that the ascertainment shows that the data frame of the first type includes at least one data frame of the second type, extracting the at least one data frame of the second type from the data frame of the first type.

7. The method as recited in claim 6, further comprising at least one of the following elements: a) analyzing the at least one data frame of the second type before the extraction and/or after the extraction, b) based on the analysis, for example, discarding the at least one data frame of the second type and/or the data frame of the first type, c) based on the analysis, outputting the at least one data frame of the second type to the network coupling element directly via a first interface, d) based on the analysis, outputting the at least one data frame of the second type to a further unit via a second interface.

8. The method as recited in claim 7, wherein the analysis includes: ascertaining a target address associated with the at least one data frame of the second type.

9. The method as recited in claim 1, further comprising:
receiving fourth data to be sent via the bus system from the at least one network coupling element in the form of at least one data frame of the second type via a first interface;
transmitting the fourth data via the bus system in the form of at least one data frame of the first type.

10. The method as recited in claim 9, wherein the transmitting includes: embedding the fourth data in at least one data frame of the first type.

11. The method as recited in claim 9, wherein the transmitting of the fourth data to the further is via a second interface, the transmitting includes: i) using at least one data frame of the first type, and/or ii) using at least one data frame of the second type, and/or iii) using another form or another type of data frame and/or data format.

12. An apparatus for processing data associated with a transmitter and/or receiver device for a serial bus system, the apparatus configured to:
a) exchange first data using data frames of a first type via the serial bus system;
b) exchange second data using data frames of a second type, with at least one network coupling element.

13. The apparatus are recited in claim 12, wherein the apparatus is a CAN XL transceiver.

14. The apparatus as recited in claim 12, wherein the apparatus is an automotive switch.

15. The apparatus as recited in claim 12, wherein the apparatus is a control unit for a motor vehicle.

16. A serial bus system for a vehicle, comprising:
an apparatus for processing data associated with a transmitter and/or receiver device for the serial bus system, the apparatus configured to:
a) exchange first data using data frames of a first type via the serial bus system;
b) exchange second data using data frames of a second type, with at least one network coupling element.

17. A communications system for a vehicle, comprising:
an apparatus for processing data associated with a transmitter and/or receiver device for a serial bus system, the apparatus configured to:
a) exchange first data using data frames of a first type via the serial bus system;
b) exchange second data using data frames of a second type, with at least one network coupling element.

18. A non-transitory computer-readable storage medium on which are stored commands for processing data associated with a transmitter and/or receiver device for a serial bus system, the commands, when executed by a computer, causing the computer to perform following steps:
a) exchanging first data using data frames of a first type via the serial bus system;
b) exchanging second data using data frames of a second type, with at least one network coupling element.

19. The method as recited in claim 1, wherein the method is used for at least one of the following elements: a) exchanging data, b) enabling direct communication of the transmitter and/or receiver device with at least one network coupling element, c) purely hardware-based transfer of at least one data frame of the second type between the bus system and at least one network coupling element, d) at least temporarily avoiding software-based processing of data frames of the second type, e) increasing efficiency with regard to processing data frames of the second type in connection with carrying the data frames of the second type via the bus system, f) directly transferring at least one Ethernet data frame, which is embedded in a CAN XL data frame or extracted from a CAN XL data frame, from a CAN XL transceiver to a network coupling element.
